(19) United States
(12) Patent Application Publication
(10) Pub. No.: US 2015/0355454 A1
(43) Pub. Date: Dec. 10, 2015

(54) ABSORBER STACK FOR MULTI-STATE INTERFEROMETRIC MODULATORS

(71) Applicant: QUALCOMM MEMS Technologies, Inc., San Diego, CA (US)

(72) Inventors: Jian Jim Ma, San Diego, CA (US); John Hyunchul HONG, San Clemente, CA (US); Edward Keat Leem CHAN, San Diego, CA (US); Yaoling PAN, San Diego, CA (US); Tallis Young CHANG, San Diego, CA (US)

(21) Appl. No.: 14/295,965

(22) Filed: Jun. 4, 2014

(51) Int. Cl. G02B 26/00; G09G 3/34; H04N 13/04

(52) U.S. Cl. CPC G02B 26/001; H04N 13/0427; G09G 3/3466; G02B 5/003

(57) ABSTRACT

Various implementations described herein involve multi-state interferometric modulators (MS-IMODs) without dielectric layers capable of affecting optical performance formed on the mirrors. The MS-IMODs disclosed herein may include a novel combination of high refractive index and low refractive index layers in the absorber stack. Some such MS-IMODs include absorber stacks having an absorber layer, a first high-index layer disposed between the absorber layer and the substrate, a low-index layer disposed between the absorber layer and the first high-index layer and a second high-index layer disposed on a side of the absorber layer facing the mirror. The absorber stack and the mirror may define a gap therebetween and may be capable of being positioned in a plurality of positions relative to one another to form a plurality of gap heights. In some implementations, the closest position corresponds with a black state gap height.

### TECHNICAL FIELD

This disclosure relates to electromechanical systems and devices, and more particularly to electromechanical systems for implementing reflective display devices.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of EMS device is called an interferometric modulator (IMOD). The term IMOD or interferometric light modulator refers to a device that selectively absorbs and/or reflects light using the principles of optical interferometric absorption. In some implementations, an IMOD display element may include a pair of conductive plates, one of which has a high reflectance and one is partially absorptive. The pair of conductive plates are capable of relative motion upon application of an appropriate electrical signal. For example, one plate may include a stationary layer deposited over, on or supported by a substrate and the other plate may include a partial absorptive membrane separated from the stationary layer by an air gap. The position of one plate in relation to another can change the spectrum of the reflected light from the IMOD display element. IMOD-based display devices have a wide range of applications, and are anticipated to be used in improving existing products and creating new products, especially those with display capabilities.

Some IMODs are bi-stable IMODs, meaning that they can be configured in only two positions, high reflectance and low reflectance. At the high reflectance position, each pixel in a bi-stable IMOD reflects only one color, which may be a primary color. In some implementations, a display including such bi-stable IMODs may incorporate three sub-pixels to display an image pixel. In a display device that includes multi-state interferometric modulators (MS-IMODs) or analog IMODs (A-IMODs), each pixel can have more than two positions (or gap spacings), and a pixel's reflective color may be determined by the gap spacing or “gap height” between an absorber stack and a mirror stack of a single IMOD. As such, each pixel can reflect multiple colors. Some A-IMODs may be positioned in a substantially continuous manner between a large number of gap heights, whereas MS-IMODs may generally be positioned in a smaller number of gap heights.

### SUMMARY

The systems, methods and devices of this disclosure each have several innovative aspects, no single one of which is solely responsible for the desirable attributes disclosed herein.

One innovative aspect of the subject matter described in this disclosure can be implemented in an IMOD. The IMOD may include a mirror, a substrate formed of transparent (or substantially transparent) material and an absorber stack disposed on the substrate. The absorber stack may include an absorber layer, a first high-index layer disposed between the absorber layer and the substrate, a low-index layer disposed between the absorber layer and the first high-index layer and a second high-index layer disposed between the absorber layer and the mirror.

The first high-index layer may have a relatively higher index of refraction than that of the substrate, the low-index layer may have a relatively lower index of refraction than that of the first high-index layer and the second high-index layer may have a relatively higher index of refraction than that of the low-index layer. The absorber stack and the mirror may define a gap therebetween and may be capable of being positioned in a plurality of positions relative to one another to form a plurality of gap heights. Each reflective color of a plurality of reflective colors of the IMOD may correspond with a gap height of the plurality of gap heights.

The second high-index layer may, for example, include SiNₓ and/or ZrO₂. In some implementations, the IMOD may include an etch stop layer disposed proximate the second high-index layer.

In some implementations, the IMOD may include a plurality of protrusions disposed on the absorber stack or the mirror. The protrusions may be capable of preventing contact between areas of the mirror and areas of the absorber stack. In some examples, each of the protrusions may extend between 5 and 20 nm from the surface on which the protrusion is formed.

In some implementations, no more than 10 nanometers of dielectric material may be formed on a side of the mirror facing the gap. Some implementations may include a passivating layer formed on the mirror and/or a passivating layer formed on the absorber stack.

In some examples, a display device may include the IMOD. The display device may include a control system capable of controlling the display device. The control system may be capable of processing image data. The control system may include a driver circuit capable of sending at least one signal to a display of the display device and a controller capable of sending at least a portion of the image data to the driver circuit. In some examples, the control system may include an image source module capable of sending the image data to the processor. The image source module may include a receiver, transceiver and/or a transmitter. The display device may include an input device capable of receiving input data and of communicating the input data to the control system.

Other innovative aspects of the subject matter described in this disclosure can be implemented in an IMOD that includes a mirror, a substrate formed of transparent (or substantially transparent) material and an absorber stack disposed on the substrate. The absorber stack may include an absorber layer. The absorber stack and the mirror may define a gap therebetween and may be capable of being positioned in a plurality of positions relative to one another to form a plurality of gap heights.

In some implementations, the IMOD may be configured in a black state gap height when the absorber stack and the mirror are positioned in a closest position relative to one another. In some examples, the black state gap height may be in the range of 5 to 20 nanometers. According to some implementations, a white state gap height of the IMOD may be larger than the black state gap height. For example, the white state gap height may be in the range of 160 to 180 nanometers.

In some implementations, the IMOD may include a plurality of protrusions disposed on the absorber stack and/or on the mirror. The protrusions may be capable of preventing contact between areas of the mirror and areas of the absorber stack. According to some implementations, each of the protrusions may extend between 5 and 20 nm from the surface on which the protrusion is formed.

In some examples, the absorber stack may include a first high-index layer disposed between the absorber layer and the substrate, a low-index layer disposed between the absorber layer and the first high-index layer and a second high-index layer disposed between the absorber layer and the mirror. The first high-index layer may have a relatively higher index of refraction than that of the substrate. The low-index layer may have a relatively lower index of refraction than that of the first high-index layer. The second high-index layer may have a relatively higher index of refraction than that of the low-index layer.

Still other innovative aspects of the subject matter described in this disclosure can be implemented in a method of forming an IMOD. The method may involve forming an absorber stack on a transparent (or substantially transparent) substrate. The absorber stack may include an absorber layer, a first high-index layer disposed between a first side of the absorber layer and the substrate a low-index layer disposed between the first side of the absorber layer and the first high-index layer, and a second high-index layer disposed on a second side of the absorber layer. The first high-index layer may have a relatively higher index of refraction than that of the substrate. The low-index layer may have a relatively lower index of refraction than that of the first high-index layer. The second high-index layer may have a relatively higher index of refraction than that of the low-index layer. In some examples, the second high-index layer may include SiNₓ and/or ZrO₂.

In some implementations, the method may involve forming a mirror stack capable of being positioned in a plurality of positions relative to the absorber stack to form a plurality of gap heights between the mirror stack and the absorber stack. Each reflective color of a plurality of reflective colors of the IMOD may correspond with a gap height of the plurality of gap heights.

In some implementations, the method may involve forming a plurality of protrusions on the absorber stack or the mirror stack. The protrusions may be capable of preventing contact between areas of the mirror stack and areas of the absorber stack.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 is an isometric view illustration depicting two adjacent interferometric modulator (IMOD) display elements in a series or array of display elements of an IMOD display device.

FIG. 2 is a system block diagram illustrating an electronic device incorporating an IMOD-based display including a three element by three element array of IMOD display elements.

FIG. 3 is a flow diagram illustrating a manufacturing process for an IMOD display or display element.

FIGS. 4A-4E are cross-sectional illustrations of various stages in a process of making an IMOD display or display element.

FIGS. 5A-5E show examples of how an IMOD may be configured to produce different colors.

FIG. 6A shows examples of layers that may be included in an IMOD.

FIG. 6B shows an example of additional features that may be included in an IMOD.

FIG. 7 shows a color spiral in u′v′ space for one example of an IMOD when the gap height ranges from 15 nm to 450 nm.

FIG. 8 shows examples of layers that may be included in an alternative IMOD.

FIG. 9A is a flow diagram illustrating an example of a process for manufacturing an IMOD display or display element.

FIG. 9B shows an example of how block 905 of FIG. 9A may be implemented.

FIGS. 10A and 10B are system block diagrams illustrating a display device 40 that includes a plurality of IMOD display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that can be configured to display an image, whether in motion (such as video) or stationary (such as still images), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Various implementations described herein involve MS-IMODs without dielectric layers capable of affecting optical performance formed on the mirrors, although some such MS-IMODs may include one or more optically inactive layers on the mirrors. Such MS-IMODs, for example, may lack high refractive index and low refractive index layers formed on the mirrors for improving a white state color, black state color and/or color saturation. Lacking such layers on the mirrors, the MS-IMODs disclosed herein may include a novel combination of high refractive index and low refractive index layers in the absorber stack. Some such MS-IMODs include absorber stacks having an absorber layer, a first high-index layer disposed between the absorber layer and the substrate, a low-index layer disposed between the absorber layer and the first high-index layer and a second high-index layer disposed on a side of the absorber layer facing the mirror. The absorber stack and the mirror may define a gap therebetween and may be capable of being positioned in a plurality of positions relative to one another to form a plurality of gap heights. In some implementations, the closest position corresponds with a black state gap height.

Particular implementations of the subject matter described in this disclosure can be implemented to realize one or more of the following potential advantages. In MS-IMODs, high refractive index and low refractive index dielectric layers have been formed on the mirrors for improving a white state color, black state color and/or color saturation. However, in the scheme when mirror is a moving element, such dielectric layers may introduce stress and stress gradient which will cause mirror warping that affects color saturation and gamut. Careful design and manufacturing processes to achieve stress balance and CTE compensation are required to achieve a flat mirror. The MS-IMODs disclosed herein may include a novel combination of high refractive index and low refractive index layers in the absorber stack which is deposited on the display substrate and less critical to thin film stress. Lacking such layers on the mirrors will simplify stress and CTE balance and consequently improve yield and reduce cost.

An example of a suitable EMS or MEMS device or apparatus, to which the described implementations may apply, is a reflective display device. Reflective display devices can incorporate interferometric modulator (IMOD) display elements that can be implemented to selectively absorb and/or reflect light incident thereon using principles of optical interference. IMOD display elements can include a partial optical absorber, a reflector that is movable with respect to the absorber, and an optical resonant cavity defined between the absorber and the reflector. In some implementations, the reflector can be moved to two or more different positions, which can change the size of the optical resonant cavity and thereby affect the reflectance of the IMOD. The reflectance spectra of IMOD display elements can create fairly broad spectral bands that can be shifted across the visible wavelengths to generate different colors. The position of the spectral band can be adjusted by changing the thickness of the optical resonant cavity. One way of changing the optical resonant cavity is by changing the position of the reflector with respect to the absorber.

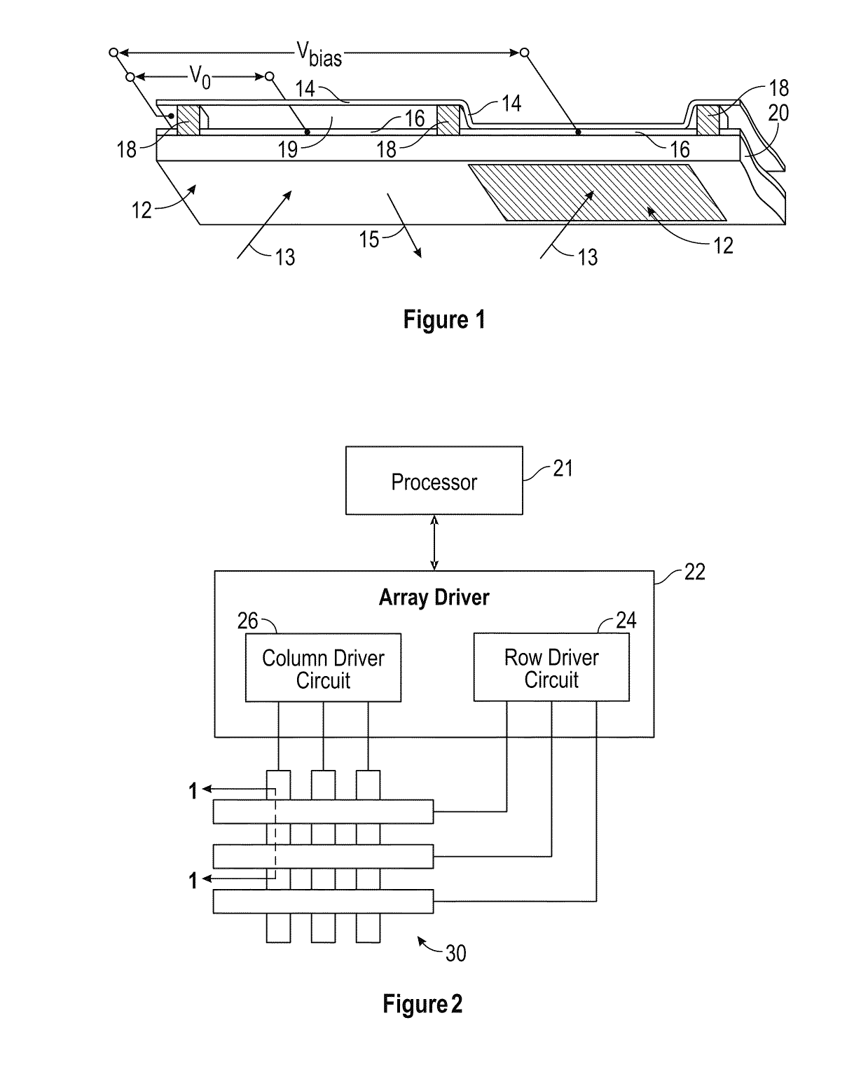

FIG. 1 is an isometric view illustration depicting two adjacent interferometric modulator (IMOD) display elements in a series or array of display elements of an IMOD display device. The IMOD display device includes one or more interferometric EMS, such as MEMS, display elements. In these devices, the interferometric MEMS display elements can be configured in either a bright or dark state. In the bright (“relaxed,” “open” or “on,” etc.) state, the display element reflects a large portion of incident visible light. Conversely, in the dark (“actuated,” “closed” or “off,” etc.) state, the display element reflects little incident visible light. MEMS display elements can be configured to reflect predominantly at particular wavelengths of light allowing for a color display in addition to black and white. In some implementations, by using multiple display elements, different intensities of color primaries and shades of gray can be achieved.

The IMOD display device can include an array of IMOD display elements which may be arranged in rows and columns. Each display element in the array can include at least a pair of reflective and semi-reflective layers, such as a movable reflective layer (i.e., a movable layer, also referred to as a mechanical layer) and a fixed partially reflective layer (i.e., a stationary layer), positioned at a variable and controllable distance from each other to form an air gap (also referred to as an optical gap, cavity or optical resonant cavity). The movable reflective layer may be moved between at least two positions. For example, in a first position, i.e., a relaxed position, the movable reflective layer can be positioned at a distance from the fixed partially reflective layer. In a second position, i.e., an actuated position, the movable reflective layer can be positioned more closely to the partially reflective layer. Incident light that reflects from the two layers can interfere constructively and/or destructively depending on the position of the movable reflective layer and the wavelength(s) of the incident light, producing either an overall reflective or non-reflective state for each display element. In some implementations, the display element may be in a reflective state when unactuated, reflecting light within the visible spectrum, and may be in a dark state when actuated, absorbing and/or destructively interfering light within the visible range. In some other implementations, however, an IMOD display element may be in a dark state when unactuated, and in a reflective state when actuated. In some implementations, the introduction of an applied voltage can drive the display elements to change states. In some other implementations, an applied charge can drive the display elements to change states.

The depicted portion of the array in FIG. 1 includes two adjacent interferometric MEMS display elements in the form of IMOD display elements 12. In the display element 12 on the right (as illustrated), the movable reflective layer 14 is illustrated in an actuated position near, adjacent or touching the optical stack 16. The voltage V_{bias} applied across the display element 12 on the right is sufficient to move and also maintain the movable reflective layer 14 in the actuated position. In the display element 12 on the left (as illustrated), a movable reflective layer 14 is illustrated in a relaxed position at a distance (which may be predetermined based on design parameters) from an optical stack 16, which includes a partially reflective layer. The voltage V₀ applied across the display element 12 on the left is insufficient to cause actuation of the movable reflective layer 14 to an actuated position such as that of the display element 12 on the right.

In FIG. 1, the reflective properties of IMOD display elements 12 are generally illustrated with arrows indicating light 13 incident upon the IMOD display elements 12, and light 15 reflecting from the display element 12 on the left. Most of the light 13 incident upon the display elements 12 may be transmitted through the transparent substrate 20, toward the optical stack 16. A portion of the light incident upon the optical stack 16 may be transmitted through the partially reflective layer of the optical stack 16, and a portion will be reflected back through the transparent substrate 20. The portion of light 13 that is transmitted through the optical stack 16 may be reflected from the movable reflective layer 14, back toward (and through) the transparent substrate 20. Interference (constructive and/or destructive) between the light reflected from the partially reflective layer of the optical stack 16 and the light reflected from the movable reflective layer 14 will determine in part the intensity of wavelength(s) of light 15 reflected from the display element 12 on the viewing or substrate side of the device. In some implementations, the transparent substrate 20 can be a glass substrate (sometimes referred to as a glass plate or panel). The glass substrate may be or include, for example, a borosilicate glass, a soda lime glass, quartz, Pyrex, or other suitable glass material. In some implementations, the glass substrate may have a thickness of 0.3, 0.5 or 0.7 millimeters, although in some implementations the glass substrate can be thicker (such as tens of millimeters) or thinner (such as less than 0.3 millimeters). In some implementations, a non-glass substrate can be used, such as a polycarbonate, acrylic, polyethylene terephthalate (PET) or polyether ether ketone (PEEK) substrate. In such an implementation, the non-glass substrate will likely have a thickness of less than 0.7 millimeters, although the substrate may be thicker depending on the design considerations. In some implementations, a non-transparent substrate, such as a metal foil or stainless steel-based substrate can be used. For example, a reverse-IMOD-based display, which includes a fixed reflective layer and a movable layer which is partially transmissive and partially reflective, may be configured to be viewed from the opposite side of a substrate as the display elements 12 of FIG. 1 and may be supported by a non-transparent substrate.

The optical stack 16 can include a single layer or several layers. The layer(s) can include one or more of an electrode layer, a partially reflective and partially transmissive layer, and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals (e.g., chromium and/or molybdenum), semiconductors, and dielectrics. The partially reflective layer can be formed of one or more layers of materials, and each of the layers can be formed of a single material or a combination of materials. In some implementations, certain portions of the optical stack 16 can include a single semi-transparent thickness of metal or semiconductor which serves as both a partial optical absorber and electrical conductor, while different, electrically more conductive layers or portions (e.g., of the optical stack 16 or of other structures of the display element) can serve to bus signals between IMOD display elements. The optical stack 16 also can include one or more insulating or dielectric layers covering one or more conductive layers or an electrically conductive/partially absorptive layer.

In some implementations, at least some of the layer(s) of the optical stack 16 can be patterned into parallel strips, and may form row electrodes in a display device as described further below. As will be understood by one having ordinary skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of supports, such as the illustrated posts 18, and an intervening sacrificial material located between the posts 18. When the sacrificial material is etched away, a defined gap 19, or optical cavity, can be formed between the movable reflective layer 14 and the optical stack 16. In some implementations, the spacing between posts 18 may be approximately 1-1000 μm, while the gap 19 may be approximately less than 10,000 Angstroms (Å).

In some implementations, each IMOD display element, whether in the actuated or relaxed state, can be considered as a capacitor formed by the fixed and moving reflective layers. When no voltage is applied, the movable reflective layer 14 remains in a mechanically relaxed state, as illustrated by the display element 12 on the left in FIG. 1, with the gap 19 between the movable reflective layer 14 and optical stack 16. However, when a potential difference, i.e., a voltage, is applied to at least one of a selected row and column, the capacitor formed at the intersection of the row and column electrodes at the corresponding display element becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated display element 12 on the right in FIG. 1. The behavior can be the same regardless of the polarity of the applied potential difference. Though a series of display elements in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. In some implementations, the rows may be referred to as “common” lines and the columns may be referred to as “segment” lines, or vice versa. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 is a system block diagram illustrating an electronic device incorporating an IMOD-based display including a three element by three element array of IMOD display elements. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, for example a display array or panel 30. The cross section of the IMOD display device illustrated in FIG. 1 is shown by the lines 1-1 in FIG. 2. Although FIG. 2 illustrates a 3×3 array of IMOD display elements for the sake of clarity, the display array 30 may contain a very large number of IMOD display elements, and may have a different number of IMOD display elements in rows than in columns, and vice versa.

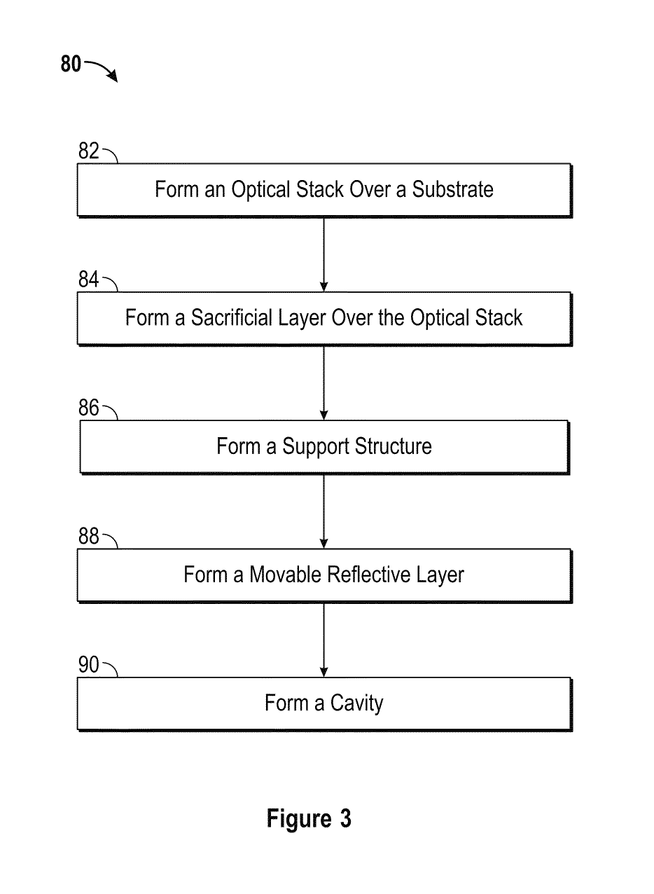

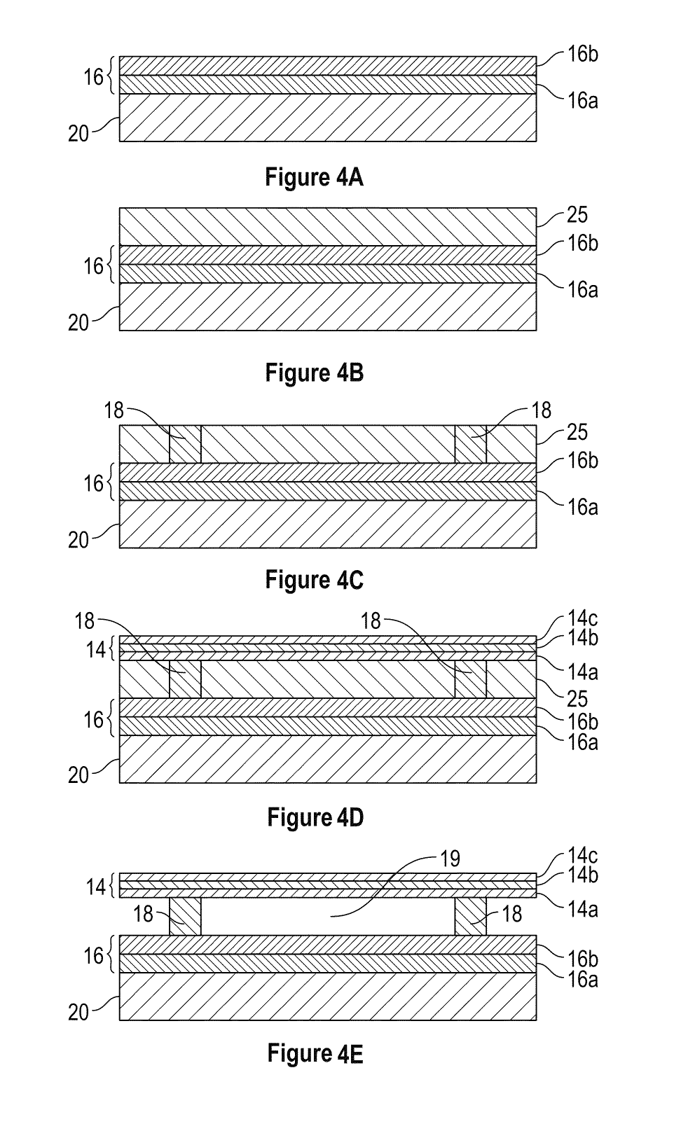

FIG. 3 is a flow diagram illustrating a manufacturing process 80 for an IMOD display or display element. FIGS. 4A-4E are cross-sectional illustrations of various stages in the manufacturing process 80 for making an IMOD display or display element. In some implementations, the manufacturing process 80 can be implemented to manufacture one or more EMS devices, such as IMOD displays or display elements. The manufacture of such an EMS device also can include other blocks not shown in FIG. 3. The process 80 begins at block 82 with the formation of the optical stack 16 over the substrate 20. FIG. 4A illustrates such an optical stack 16 formed over the substrate 20. The substrate 20 may be a transparent substrate such as glass or plastic such as the materials discussed above with respect to FIG. 1. The substrate 20 may be flexible or relatively stiff and unbending, and may have been subjected to prior preparation processes, such as cleaning, to facilitate efficient formation of the optical stack 16. As discussed above, the optical stack 16 can be electrically conductive, partially transparent, partially reflective, and partially absorptive, and may be fabricated, for example, by depositing one or more layers having the desired properties onto the transparent substrate 20.

In FIG. 4A, the optical stack 16 includes a multilayer structure having sub-layers 16a and 16b, although more or fewer sub-layers may be included in some other implementations. In some implementations, one of the sub-layers 16a and 16b can be configured with both optically absorptive and electrically conductive properties, such as the combined conductor/absorber sub-layer 16a. In some implementations, one of the sub-layers 16a and 16b can include molybdenum-chromium (molychrome or MoCr), or other materials with a suitable complex refractive index. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as an upper sub-layer 16b that is deposited over one or more underlying metal and/or oxide layers (such as one or more reflective and/or conductive layers). In addition, the optical stack 16 can be patterned into individual and parallel strips that form the rows of the display. In some implementations, at least one of the sub-layers of the optical stack, such as the optically absorptive layer, may be quite thin (e.g., relative to other layers depicted in this disclosure), even though the sub-layers 16a and 16b are shown somewhat thick in FIGS. 4A-4E.

The process 80 continues at block 84 with the formation of a sacrificial layer 25 over the optical stack 16. Because the sacrificial layer 25 is later removed (see block 90) to form the cavity 19, the sacrificial layer 25 is not shown in the resulting IMOD display elements. FIG. 4B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIG. 4E) having a desired design size. Deposition of the sacrificial material may be carried out using deposition techniques such as physical vapor deposition (PVD, which includes many different techniques, such as sputtering), plasma-enhanced chemical vapor deposition (PECVD), thermal chemical vapor deposition (thermal CVD), or spin-coating.

The process 80 continues at block 86 with the formation of a support structure such as a support post 18. The formation of the support post 18 may include patterning the sacrificial layer 25 to form a support structure aperture, then depositing a material (such as a polymer or an inorganic material, like silicon oxide) into the aperture to form the support post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the support post 18 contacts the substrate 20. Alternatively, as depicted in FIG. 4C, the aperture formed in the sacrificial layer 25 can extend through the sacrificial layer 25, but not through the optical stack 16. For example, FIG. 4E illustrates the lower ends of the support posts 18 in contact with an upper surface of the optical stack 16. The support post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 4C, but also can extend at least partially over a portion of the sacrificial layer 25. As noted above, the patterning of the sacrificial layer 25 and/or the support posts 18 can be performed by a masking and etching process, but also may be performed by alternative patterning methods.

The process 80 continues at block 88 with the formation of a movable reflective layer or membrane such as the movable reflective layer 14 illustrated in FIG. 44. The movable reflective layer 14 may be formed by employing one or more deposition steps, including, for example, reflective layer (such as aluminum, aluminum alloy, or other reflective materials) deposition, along with one or more patterning, masking and/or etching steps. The movable reflective layer 14 can be patterned into individual and parallel strips that form, for example, the columns of the display. The movable reflective layer 14 can be electrically conductive, and referred to as an electrically conductive layer. In some implementations, the movable reflective layer 14 may include a plurality of sub-layers 14a, 14b and 14c as shown in FIG. 4D. In some implementations, one or more of the sub-layers, such as sub-layers 14a and 14c, may include highly reflective sub-layers selected for their optical properties, and another sub-layer 14b may include a mechanical sub-layer selected for its mechanical properties. In some implementations, the mechanical sub-layer may include a dielectric material. Since the sacrificial layer 25 is still present in the partially fabricated IMOD display element formed at block 88, the movable reflective layer 14 is typically not movable at this stage. A partially fabricated IMOD display element that contains a sacrificial layer 25 also may be referred to herein as an “unreleased” IMOD.

The process 80 continues at block 90 with the formation of a cavity 19. The cavity 19 may be formed by exposing the sacrificial material 25 (deposited at block 84) to an etchant. For example, an etchable sacrificial material such as Mo or amorphous Si may be removed by dry chemical etching by exposing the sacrificial layer 25 to a gaseous or vaporous etchant, such as vapors derived from solid XeF₂ for a period of time that is effective to remove the desired amount of material. The sacrificial material is typically selectively removed relative to the structures surrounding the cavity 19. Other etching methods, such as wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD display element may be referred to herein as a “released” IMOD.

In some implementations, the packaging of an EMS component or device, such as an IMOD-based display, can include a backplate (alternatively referred to as a backplane, back glass or recessed glass) which can be configured to protect the EMS components from damage (such as from mechanical interference or potentially damaging substances). The backplate also can provide structural support for a wide range of components, including but not limited to driver circuitry, processors, memory, interconnect arrays, vapor barriers, product housing, and the like. In some implementations, the use of a backplate can facilitate integration of components and thereby reduce the volume, weight, and/or manufacturing costs of a portable electronic device.

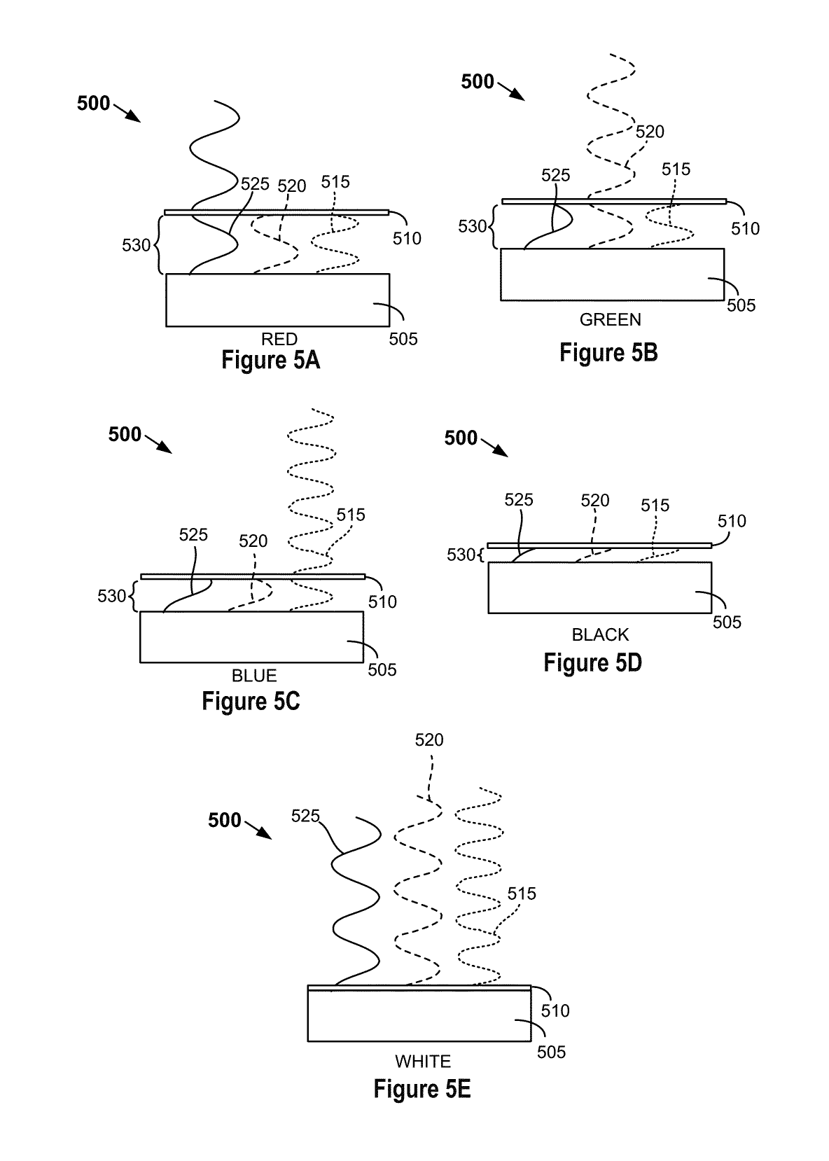

FIGS. 5A-5E show examples of how a single IMOD (IMOD) may be configured to produce different colors. Alternative implementations, in which similar configurations of the IMOD produce colors different from those described with reference to FIGS. 5A-5E, are described in detail below. Multistate IMODs (MS-IMODs) and analog IMODs (A-IMODs) are both considered to be examples of the broader class of IMODs.

In an MS-IMOD, a pixel's reflective color may be varied by changing the gap height between an absorber stack and a mirror stack. In FIGS. 5A-5E, the IMOD 500 includes the mirror stack 505 and the absorber stack 510. In this implementation, the absorber stack 510 is partially reflective and partially absorptive. Here, the mirror stack 505 includes at least one metallic reflective layer, which also may be referred to herein as a mirrored surface or a metal mirror.

In some implementations, the absorber layer may be formed of a partially absorptive and partially reflective layer. The absorber layer may be part of an absorber stack that includes other layers, such as one or more dielectric layers, an electrode layer, etc. According to some such implementations, the absorber stack may include a dielectric layer, a metal layer and a passivation layer. In some implementations, the dielectric layer may be formed of SiO₂, SiON, MgF₂, Al₂O₃ and/or other dielectric materials. In some implementations, the metal layer may be formed of Cr, W, Ni, V, Ti, Rh, Pt, Ge, Co and/or MoCr. In some implementations, the passivation layer may include Al₂O₃ or another dielectric material.

The mirror may, for example, be formed of one or more reflective metals such as Al, silver, etc. In some MS-IMODs, the mirror may be part of a mirror stack that includes other layers, such as one or more dielectric layers. Such dielectric layers may be formed of TiO₂, Si₃N₄, ZrO₂, Ta₂O₅, Sb₂O₃, HfO₂, Sc₂O₃, In₂O₃, Sn:In₂O₃, SiO₂, SiON, MgF₂, Al₂O₃, HfF₄, YbF₃, Na₃AlF₆ and/or other dielectric materials.

In FIGS. 5A-5E, the mirror stack 505 is shown at five positions relative to the absorber stack 510. However, an IMOD 500 may be movable between substantially more than 5 positions relative to the mirror stack 505. For example, in some A-IMOD implementations, the gap height 530 between the mirror stack 505 and the absorber stack 510 may be varied in a substantially continuous manner. In some such IMODs 500, the gap height 530 may be controlled with a high level of precision, e.g., with an error of 10 nanometers (nm) or less. Although the absorber stack 510 includes a single absorber layer in this example, alternative implementations of the absorber stack 510 may include multiple absorber layers. Moreover, in alternative implementations, the absorber stack 510 may not be partially reflective.

An incident wave having a wavelength λ will interfere with its own reflection from the mirror stack 505 to create a standing wave with local peaks and nulls. The first null is λ/2 from the mirror and subsequent nulls are located at λ/2 intervals. For that wavelength, a thin absorber layer placed at one of the null positions will absorb very little energy.

Referring first to FIG. 5A, when the gap height 530 is substantially equal to the half wavelength of a red wavelength of light 525 (also referred to herein as a red color), the absorber stack 510 is positioned at the null of the red standing wave interference pattern. The absorption of the red wavelength of light 525 is near zero because there is almost no red light at the absorber. At this configuration, constructive interference appears between red wavelengths of light reflected from the absorber stack 510 and red wavelengths of light reflected from the mirror stack 505. Therefore, light having a wavelength substantially corresponding to the red wavelength of light 525 is reflected efficiently. Light of other colors, including the blue wavelength of light 515 and the green wavelength of light 520, has a high intensity field at the absorber and is not reinforced by constructive interference. Instead, such light is substantially absorbed by the absorber stack 510.

FIG. 5B depicts the IMOD 500 in a configuration wherein the mirror stack 505 is moved closer to the absorber stack 510 (or vice versa). In this example, the gap height 530 is substantially equal to the half wavelength of the green wavelength of light 520. The absorber stack 510 is positioned at the null of the green standing wave interference pattern. The absorption of the green wavelength of light 520 is near zero because there is almost no green light at the absorber. At this configuration, constructive interference appears between green light reflected from the absorber stack 510 and green light reflected from the mirror stack 505. Light having a wavelength substantially corresponding to the green wavelength of light 520 is reflected efficiently. Light of other colors, including the red wavelength of light 525 and the blue wavelength of light 515, is substantially absorbed by the absorber stack 510.

In FIG. 5C, the mirror stack 505 is moved closer to the absorber stack 510 (or vice versa), so that the gap height 530 is substantially equal to the half wavelength of the blue wavelength of light 515. Light having a wavelength substantially corresponding to the blue wavelength of light 515 is reflected efficiently. Light of other colors, including the red wavelength of light 525 and the green wavelength of light 520, is substantially absorbed by the absorber stack 510.

In FIG. 5D, however, the IMOD 500 is in a configuration wherein the gap height 530 is substantially equal to 1/4 of the wavelength of the average color in the visible range. In such arrangement, the absorber is located near the intensity peak of the interference standing wave; the strong absorption due to high field intensity together with destructive interference between the absorber stack 510 and the mirror stack 505 causes relatively little visible light to be reflected from the IMOD 500. This configuration may be referred to herein as a “black state.” In some such implementations, the gap height 530 may be made larger or smaller than shown in FIG. 5D, in order to reinforce other wavelengths that are outside the visible range. Accordingly, the configuration of the IMOD 500 shown in FIG. 5D provides merely one example of a black state configuration of the IMOD 500.

FIG. 5E depicts the IMOD 500 in a configuration wherein the absorber stack 510 is in close proximity to the mirror stack 505. In this example, the gap height 530 is negligible because the absorber stack 510 is substantially adjacent to the mirror stack 505. Light having a broad range of wavelengths is reflected efficiently from the mirror stack 505 without being absorbed to a significant degree by the absorber stack 510. This configuration may be referred to herein as a “white state.” However, in some implementations the absorber stack 510 and the mirror stack 505 may be separated to reduce stiction caused by charging via the strong electric field that may be produced when the two layers are brought close to one another. In some implementations, one or more dielectric layers with a total thickness of about λ/2 may be disposed on the surface of the absorber layer and/or the mirrored surface. As such, the white state may correspond to a configuration wherein the absorber layer is placed at the first null of the standing wave from the mirrored surface of the mirror stack 505.

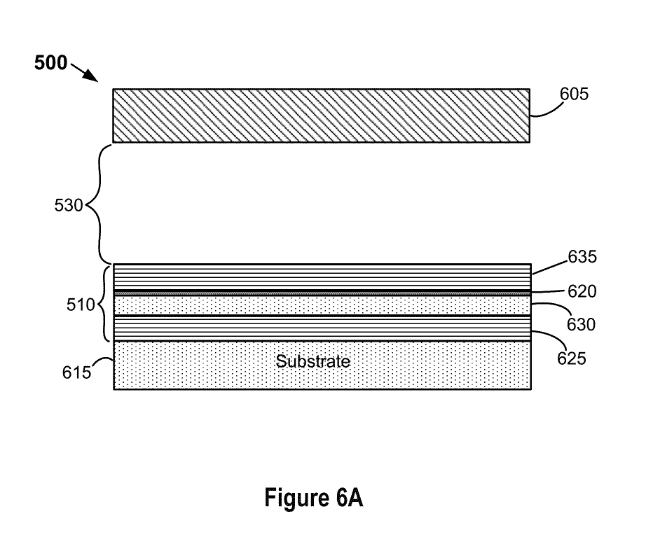

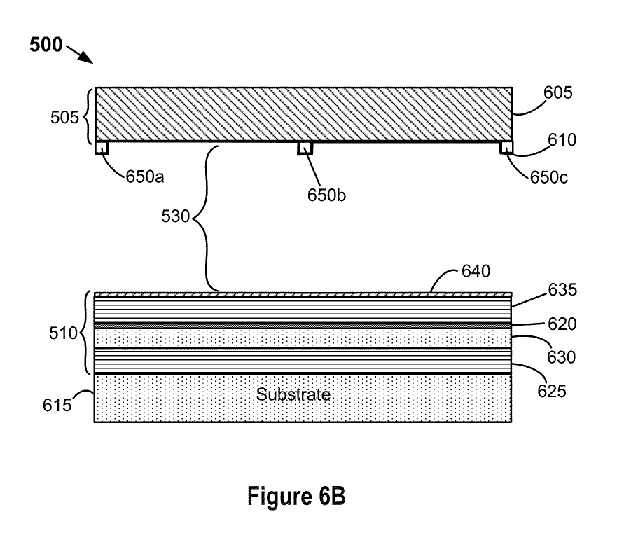

FIG. 6A shows an example of layers that may be included in an IMOD. The types, arrangements and thicknesses of materials shown in the IMOD stacks of this disclosure, including those shown in FIG. 6A, are merely made by way of example. In some examples, the mirror 605 is formed of AlCu and has a thickness of approximately 50 nm. However, the mirror 605 may be formed of other reflective metals such as Al, silver, etc., and may have a different thickness. Some implementations of the IMOD 500 may include a non-metal mirror. In some implementations, the mirror 605 may be formed on a stiff mechanical layer, such as a layer that includes SiO₂, which does not provide any optical function and does not require a precise thickness control.

As shown in FIG. 6A, the absorber stack 510 and the mirror 605 define a gap therebetween. In this example, the IMOD 500 is an MS-IMOD. Accordingly, in this example the mirror 605 is capable of being positioned in a plurality of positions relative to the absorber 510, to form a plurality of gap heights 530. Here, the IMOD 500 is capable of producing a plurality of reflective colors, including but not limited to red, green, blue, black and white. Each reflective color corresponds with a gap height of the plurality of gap heights. In this example, the mirror 605 of IMOD 500 is movable relative to the absorber stack 510. However, in alternative implementations the absorber stack 510 may be movable relative to the mirror 605.

The absorber stack 510 is formed on a substrate 615, which may be transparent or substantially transparent. In this example, the substrate 615 is formed of glass. However, in other implementations the substrate 615 may be formed of one or more other substantially transparent materials, such as plastic, a polymer, etc.

Here, the absorber stack 510 includes an absorber layer 620 and a high-index layer 625 disposed between the absorber layer 620 and the substrate 615. In this example, the high-index layer 625 has a relatively higher index of refraction than that of the substrate 615. However, in some implementations (e.g., implementations having a substrate 615 with a relatively high index of refraction), the high-index layer 625 may not have a relatively higher index of refraction than that of the substrate 615.

In this example, the absorber stack 510 includes a low-index layer 630 a low-index layer disposed between the absorber layer 620 and the high-index layer 625. Here, the low-index layer 630 has a relatively lower index of refraction than that of the high-index layer 625. However, in some implementation, the absorber stack 510 may not include the low index layer 630.

In the implementation shown in FIG. 6A, the absorber stack 510 includes a high-index layer 635 disposed between the absorber layer 620 and the mirror 605. Here, the high-index layer 635 has a relatively higher index of refraction than that of the low-index layer 630. In some implementations, the high-index layer 635 and the high-index layer 625 may be formed of the same material(s). The high-index layer 635 can improve the white state of the IMOD 500. In other words, an IMOD 500 that includes the high-index layer 635 can produce a white state that is relatively closer to the white “color” of CIE Standard Illuminant D65 than an IMOD 500 that does not include the high-index layer 635. The high index layer 635 can reduce the separation of the nulls of the interference standing wave between different wavelengths; therefore, the absorber stack 510 can be positioned to achieve minimum absorption to all the visible wavelengths when the gap height 530 is set to the white state.

In some implementations, the high-index layer 625 and the low-index layer 630, in combination, may form an impedance-matching layer. The impedance-matching layer may include a high-dispersion layer (corresponding with the high-index layer 625) and a low-dispersion layer (corresponding with the low-index layer 630). In some examples, the low dispersion layer may include SiO₂ or SiON and the high-dispersion layer may include TiO₂ or SiNₓ, e.g., Si₃N₄. In some implementations, the dispersions and/or the indices of refraction of the low-dispersion layer and the high-dispersion layer may be balanced. The thicknesses of the absorber layer 620, the high-index layer 625 and the low-index layer 630 may be optimized to significantly reduce the reflection when the IMOD color state is black, such that a dark black state may be achieved.

In one example, the high-index layer 625 includes SiNₓ and has a thickness of approximately 48 nm, the low-index layer 630 is formed of SiO₂ and has a thickness of approximately 32 nm, the absorber layer 620 is formed of MoCr and has a thickness of approximately 7 nm and the high-index layer 635 is formed of ZrO₂ and has a thickness of approximately 49 nm. However, in other implementations, layers of the absorber stack 610 may be formed of other materials and may have different thicknesses. For example, in some implementations disclosed herein, the high-index layer 635 may be formed of SiNₓ. Other implementations of the IMOD 500 may include more or fewer layers and/or features.

FIG. 6B shows examples of additional features that may be included in an IMOD. Many of the features of the IMOD 500 shown in FIG. 6B are substantially similar to those shown in FIG. 6A. However, the IMOD 500 shown in FIG. 6B also includes a dielectric layer 610 on the mirror 605 and a dielectric layer 640 on the absorber stack 610. In this example, the dielectric layer 610 and the dielectric layer 640 may function as passivating layers and/or as anti-stiction layers.

In some implementations, the dielectric layer 610 and the dielectric layer 640 have little or no optical effect for wavelengths in the visible range. For example, the dielectric layers 610 and/or 640 may have a thickness of 20 nm or less, 15 nm or less, 10 nm or less, 5 nm or less, etc. In one example, the dielectric layers 610 and 640 may have a thickness of approximately 3 nm. In some implementations, the dielectric layers 610 and/or 640 may have a thickness that is less than 1/10 of a wavelength of light in the visible range, less than 1/20 of a wavelength of light in the visible range, less than 1/30 of a wavelength of light in the visible range, less than 1/40 of a wavelength of light in the visible range, etc. In some implementations, the dielectric layers 610 and/or 640 may be formed via atomic layer deposition (ALD).

In this implementation, the IMOD 500 also includes protrusions 650a-650c disposed on the mirror stack 505. In this example, the protrusions are capable of preventing large area contact between areas of the mirror stack 505 and areas of the absorber stack 510. Here, the protrusions 650a-650c are formed on the mirror 605 and the dielectric layer 610 is formed on the protrusions 650a-650c and on portions of the mirror 605. In some implementations, each of the protrusions 650 may extend between 5 nm and 20 nm from the surface on which the protrusion 650 is formed.

The size, number and arrangement of the protrusions 650 of the implementations shown and described herein are merely made by way of example. Other implementations may have more or fewer of the protrusions 650, may have at least some of the protrusions 650 disposed on the absorber stack 510 or may not include the protrusions 650 at all. However, including the protrusions 650 may be advantageous, particularly for implementations in which a gap height 530 for a black state or a white state may be small, e.g., on the order of 5 nm to 20 nm. In some implementations, for example, the IMOD 500 may be capable of producing a black state when the gap height 530 is in the range of 10-20 nm, e.g., approximately 15 nm.

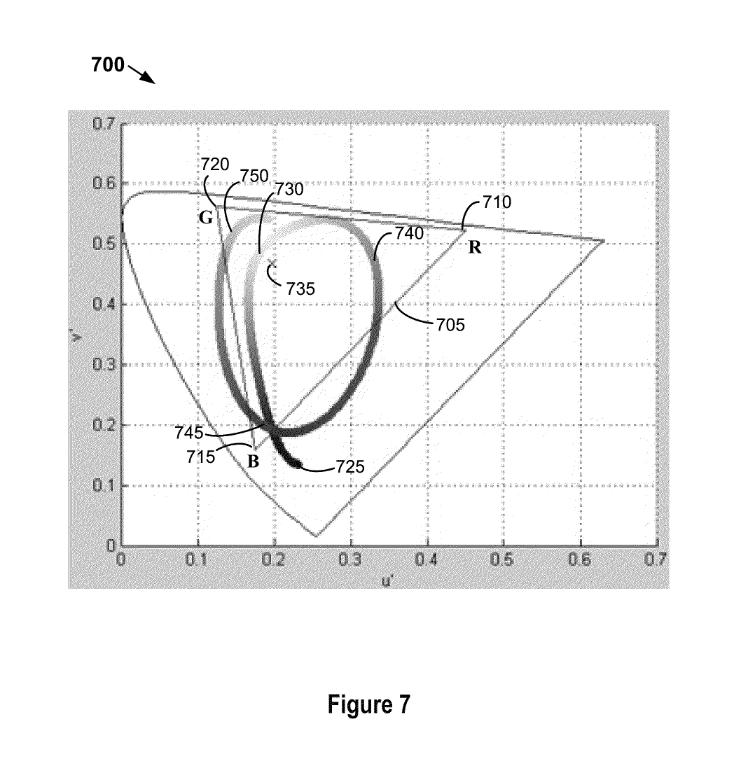

FIG. 7 shows a color spiral in u′v′ space for one example of an IMOD when the gap height ranges from 15 nm to 450 nm. The IMOD may correspond with IMOD 500 of FIG. 6A or FIG. 6B. In graph 700, the triangle 705 represents the sRGB color space. FIG. 7 indicates the red vertex 710, the blue vertex 715 and the green vertex 720 of the sRGG color space 705.

In this example, the position 725 indicates the response of the IMOD 500 at a gap height 530 of 15 nm, which corresponds to a black state of the IMOD 500. Here, the position 730 indicates the response at a gap height 530 of approximately 170 nm, which corresponds to a white state. The element 735 indicates the position of CIE Standard Illuminant D65. In this example, the positions 740, 745 and 750 indicate responses at gap heights 530 of approximately 245 nm, 330 nm and 445 nm, which correspond to a red state, a blue state and a green state, respectively.

As indicated by FIG. 7, in some implementations the IMOD 500 may be configured to have a gap height 530 that corresponds to a black state when the absorber stack 510 and the mirror 605 (or the mirror stack 505) are positioned in a closest position relative to one another. Such a gap height may be referred to herein as a “black state gap height.” In some implementations of IMOD 500, the black state gap height may be in the range of 5 to 20 nm. In such implementations, a gap height 530 that corresponds to a white state of the IMOD 500 (which may be referred to herein as a “white state gap height”) may be larger than a black state gap height. In some implementations, the white state gap height may be in the range of 160 to 180 nm.

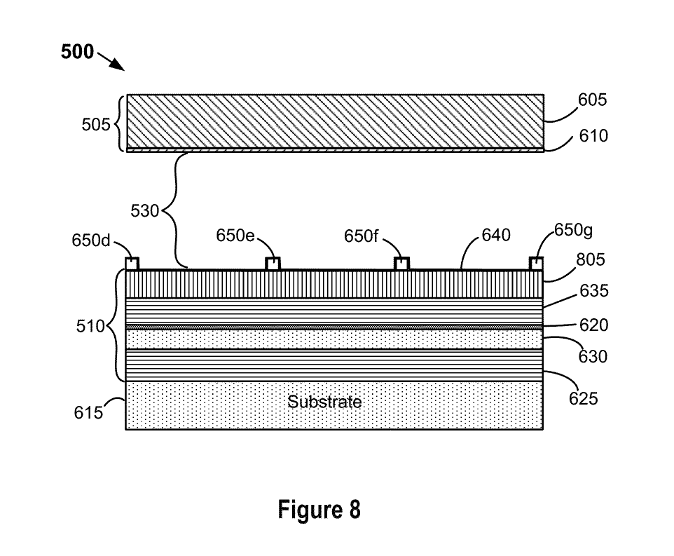

FIG. 8 shows examples of layers that may be included in an alternative IMOD. In this example, the IMOD 500 includes the protrusions 650d-650g. In this implementation, the protrusions 650d-650g are disposed on the absorber stack 510.

Moreover, in this example the absorber stack 510 includes a dielectric layer 805 disposed proximate the high-index layer 635. Specifically, in this implementation the dielectric layer 805 disposed between the high-index layer 635 and the gap. Here, the dielectric layer 640 is disposed on the protrusions 650d-650g and on portions of the dielectric layer 805. In this implementation, the dielectric layer 805 includes AlOₓ and has a thickness of approximately 11 nm. However, in other implementations the dielectric layer 805 may be formed of a different material and/or have a different thickness.

In some implementations, the dielectric layer 805 may function as an etch stop layer and/or as a passivation layer. For example, in some implementations the high-index layer 635 may include SiNₓ. Such implementations have the potential advantage that SiNₓ can be deposited at a faster rate than ZrO₂ and with better uniformity. Such implementations may benefit from including the dielectric layer 805 as a passivation layer and/or an etch stop layer. For example, the dielectric layer 805 may protect the SiNx from being attacked (e.g., by XeF₂ or another such chemical) during a process of removing sacrificial material to “release” the mirror stack 505 from the absorber stack 510. Such implementations of the IMOD 500 may produce a color spiral that is similar to that shown in FIG. 7. However, because the refractive index of SiNₓ is lower than that of ZrO₂, there may be a slight degradation of the black state color and white state color of the IMOD 500 shown in FIG. 8, as compared to those of the IMOD 500 shown in FIGS. 6A and 6B.

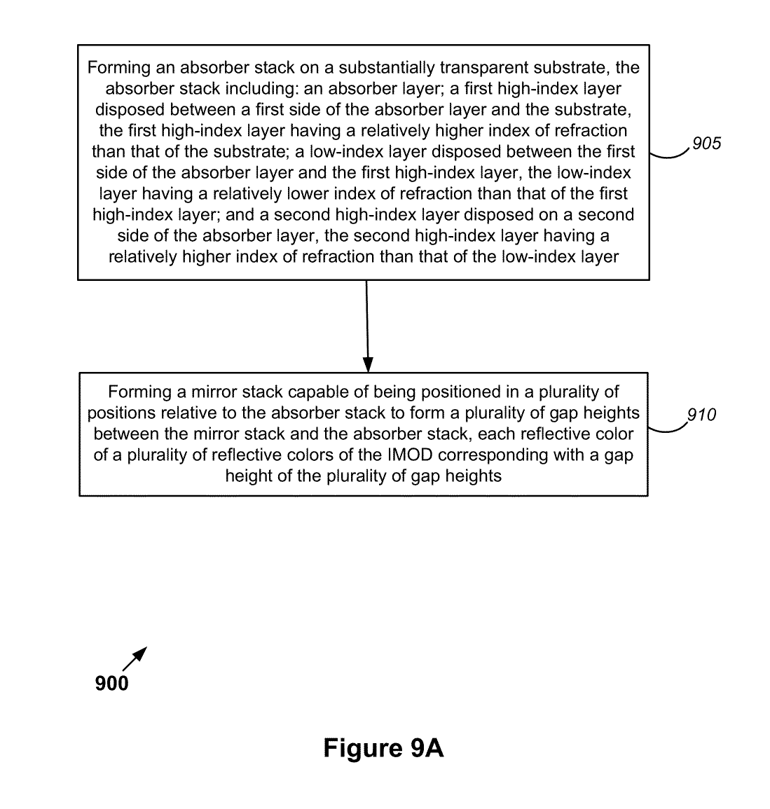

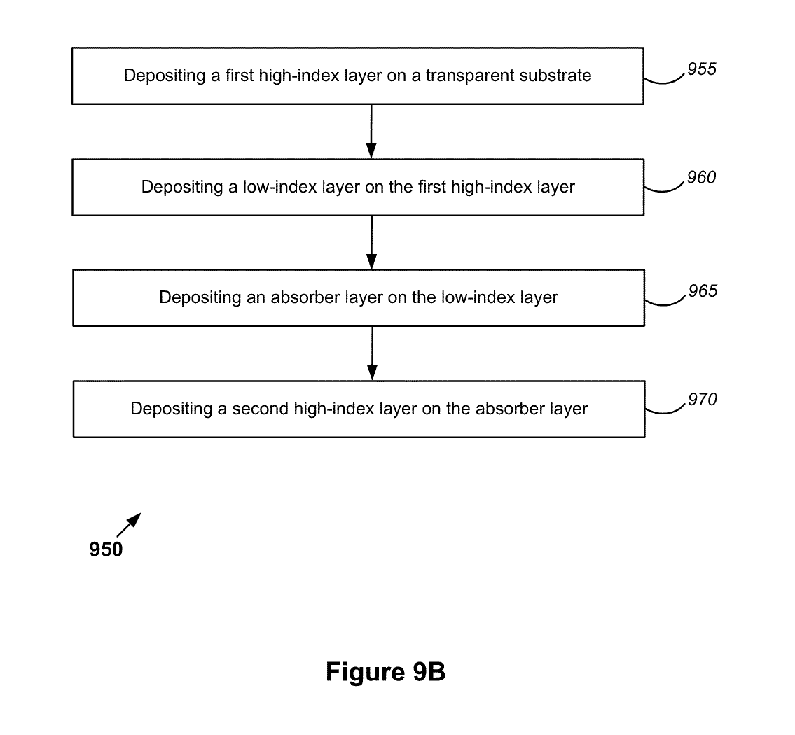

FIG. 9A is a flow diagram illustrating an example of a process for manufacturing an IMOD display or display element. The types and thicknesses of the materials used in process 900 (and process 950 of FIG. 9B) may correspond with those described with reference to the corresponding layers, feature, etc., disclosed elsewhere herein. The materials and thicknesses of the layers described in process 900 may, for example, correspond with those described above with reference to FIGS. 6A, 6B and 8.

Process 900 of FIG. 9A may, in some implementations, provide examples of blocks in a process such as that described above with reference to FIGS. 3 and 4A-4E. In some implementations, for example, block 905 of FIG. 9A may correspond, at least in part, to block 82 of FIG. 3 and block 910 of FIG. 9A may correspond, at least in part, to block 88 of FIG. 3.

In this example, block 905 involves forming an absorber stack, such as the absorber stack 510 disclosed herein, on a substrate. Here, the substrate is a transparent or substantially transparent substrate, such as the substrate 615 disclosed herein.

In this example, the absorber stack includes an absorber layer and a first high-index layer disposed between a first side of the absorber layer and the substrate. The first high-index layer may have a relatively higher index of refraction than that of the substrate. Here, the absorber stack includes a low-index layer disposed between the first side of the absorber layer and the first high-index layer. In this example, the low-index layer has a relatively lower index of refraction than that of the first high-index layer. In this implementation, the absorber stack includes a second high-index layer disposed on a second side of the absorber layer. In this example, the second high-index layer has a relatively higher index of refraction than that of the low-index layer.

In the example shown in FIG. 9A, block 910 involves forming a mirror stack. Block 910 may, for example, involve forming a mirror stack as disclosed herein, without dielectric layers formed on the mirror that are capable of affecting optical performance. However, the mirror stack may include a thin passivating or anti-stiction layer, such as the dielectric layer 610 shown in FIG. 6B. In this example, block 910 involves forming a mirror stack capable of being positioned in a plurality of positions relative to the absorber stack to form a plurality of gap heights between the mirror stack and the absorber stack. Each reflective color of a plurality of reflective colors of the IMOD may correspond with a gap height of the plurality of gap heights.

FIG. 9B shows an example of how block 905 of FIG. 9A may be implemented. The materials and thicknesses of the layers described in process 950 may, for example, correspond with those described above with reference to FIGS. 6A, 6B and 8. In this example, process 950 begins with block 955, which involves depositing a first high-index layer on a substrate. The first high-index layer may, in some implementations, have a relatively higher index of refraction than that of the substrate. The substrate may be a transparent or substantially transparent substrate.

Here, block 960 involves depositing a low-index layer on the first high-index layer. In this example, the low-index layer has a relatively lower index of refraction than that of the first high-index layer.

In this implementation, block 965 involves depositing an absorber layer on the low-index layer. Here, block 970 involves depositing a second high-index layer on the absorber layer. In this example, the second high-index layer has a relatively higher index of refraction than that of the low-index layer.

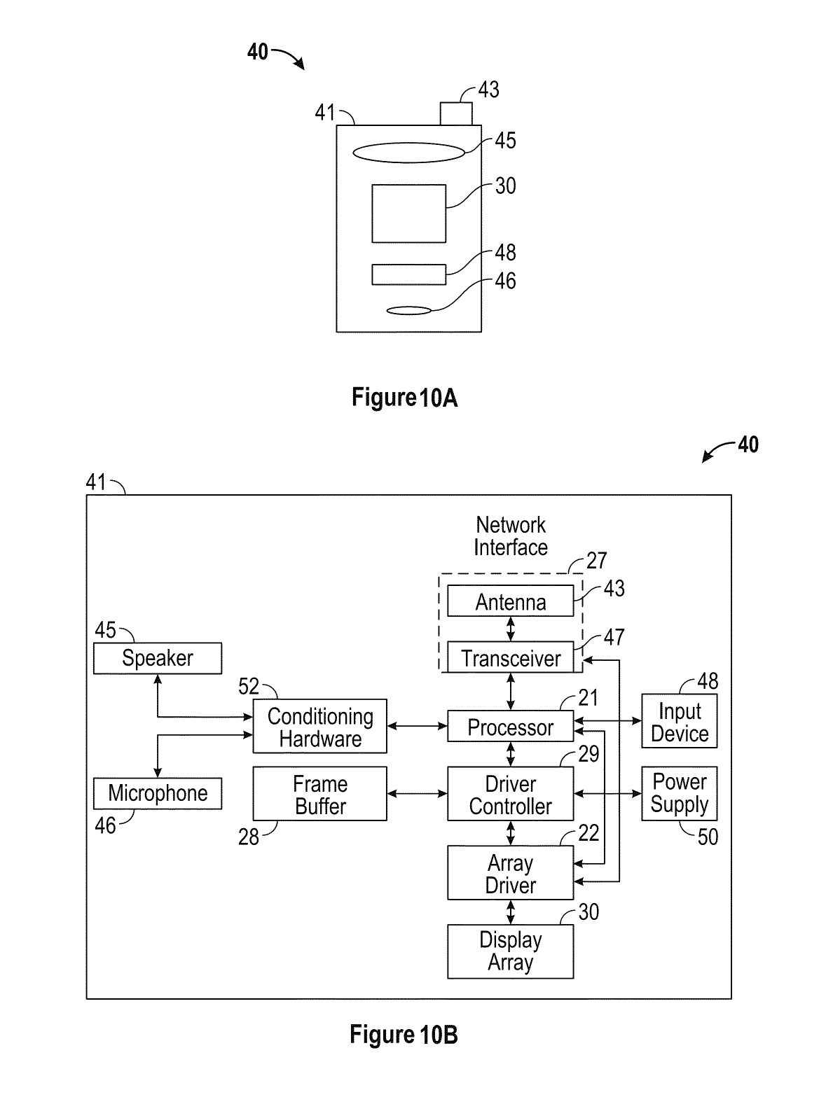

FIGS. 10A and 10B are system block diagrams illustrating a display device 40 that includes a plurality of IMOD display elements. In some implementations, the IMOD display elements may include IMODs 500 as described elsewhere herein. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD-based display. The display may include IMODs such as those described herein.

The components of the display device 40 are schematically illustrated in FIG. 10A. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 10A, can be configured to function as a memory device and be configured to communicate with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11 a, b, g, n, and further implementations thereof. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements.

In some implementations, the driver controller 29, the array driver 22, and the display array 30 are appropriate for any of the types of displays described herein. For example, the driver controller 29 can be a conventional display controller or a bi-stable display controller (such as an IMOD display element controller). Additionally, the array driver 22 can be a conventional driver or a bi-stable display driver (such as an IMOD display element driver). Moreover, the display array 30 can be a conventional display array or a bi-stable display array (such as a display including an array of IMOD display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The steps of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of, e.g., an IMOD display element as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, a person having ordinary skill in the art will readily recognize that such operations need not be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An interferometric modulator (IMOD), comprising:
a mirror;
a substrate formed of substantially transparent material; and
an absorber stack disposed on the substrate, the absorber stack including:
an absorber layer;
a first high-index layer disposed between the absorber layer and the substrate, the first high-index layer having a relatively higher index of refraction than that of the substrate;
a low-index layer disposed between the absorber layer and the first high-index layer, the low-index layer having a relatively lower index of refraction than that of the first high-index layer; and
a second high-index layer disposed between the absorber layer and the mirror, the second high-index layer having a relatively higher index of refraction than that of the low-index layer, wherein:
the absorber stack and the mirror define a gap therebetween and are capable of being positioned in a plurality of positions relative to one another to form a plurality of gap heights; and
each reflective color of a plurality of reflective colors of the IMOD corresponds with a gap height of the plurality of gap heights.

2. The IMOD of claim 1, further comprising an etch stop layer disposed proximate the second high-index layer.

3. The IMOD of claim 2, wherein the second high-index layer includes SiNₓ.

4. The IMOD of claim 1, wherein the second high-index layer includes ZrO₂.

5. The IMOD of claim 1, further comprising a plurality of protrusions disposed on the absorber stack or the mirror, the protrusions being capable of preventing contact between areas of the mirror and areas of the absorber stack.

6. The IMOD of claim 5, wherein each of the protrusions extends between 5 and 20 nm from the surface on which the protrusion is formed.

7. The IMOD of claim 1, wherein no more than 10 nanometers of dielectric material is formed on a side of the mirror facing the gap.

8. The IMOD of claim 1, further comprising a passivating layer formed on the mirror.

9. The IMOD of claim 1, further comprising a passivating layer formed on the absorber stack.

10. A display device that includes the IMOD of claim 1, wherein the display device includes a control system capable of controlling the display device and wherein the control system is capable of processing image data.

11. The display device of claim 10, wherein the control system further comprises:
a driver circuit capable of sending at least one signal to a display of the display device; and
a controller capable of sending at least a portion of the image data to the driver circuit.

12. The display device of claim 10, wherein the control system further comprises:
an image source module capable of sending the image data to the processor, wherein the image source module includes at least one of a receiver, transceiver, and transmitter.

13. The display device of claim 10, further comprising:
an input device capable of receiving input data and of communicating the input data to the control system.

14. An interferometric modulator (IMOD), comprising:
a mirror;
a substrate formed of substantially transparent material; and
an absorber stack disposed on the substrate, the absorber stack including an absorber layer, wherein:
the absorber stack and the mirror define a gap therebetween and are capable of being positioned in a plurality of positions relative to one another to form a plurality of gap heights; and
the IMOD is configured in a black state gap height when the absorber stack and the mirror are positioned in a closest position relative to one another.

15. The IMOD of claim 14, wherein the black state gap height is in the range of 5 to 20 nanometers.

16. The IMOD of claim 14, wherein a white state gap height of the IMOD is larger than the black state gap height.

17. The IMOD of claim 16, wherein the white state gap height is in the range of 160 to 180 nanometers.

18. The IMOD of claim 14, further comprising a plurality of protrusions disposed on the absorber stack or the mirror, the protrusions being capable of preventing contact between areas of the mirror and areas of the absorber stack.

19. The IMOD of claim 18, wherein each of the protrusions extends between 5 and 20 nm from the surface on which the protrusion is formed.

20. The IMOD of claim 14, wherein the absorber stack further comprises:
a first high-index layer disposed between the absorber layer and the substrate, the first high-index layer having a relatively higher index of refraction than that of the substrate;
a low-index layer disposed between the absorber layer and the first high-index layer, the low-index layer having a relatively lower index of refraction than that of the first high-index layer; and
a second high-index layer disposed between the absorber layer and the mirror, the second high-index layer having a relatively higher index of refraction than that of the low-index layer.

21. An interferometric modulator (IMOD), comprising:
a mirror;
means for partially absorbing light incident upon, and reflected from, the mirror; and
means for positioning the means for partially absorbing light and the mirror in a plurality of positions relative to one another to form a plurality of gap heights, each reflective color of a plurality of reflective colors of the IMOD corresponding with a gap height of the plurality of gap heights, wherein the means for partially absorbing light includes means for producing a black state of the IMOD when the positioning means positions the means for partially absorbing light and the mirror in a closest position relative to one another, the closest position corresponding with a black state gap height.

22. The IMOD of claim 21, wherein the black state gap height is in the range of 5 to 20 nanometers.

23. The IMOD of claim 21, wherein a white state gap height of the IMOD is larger than the black state gap height.

24. The IMOD of claim 23, wherein the white state gap height is in the range of 160 to 180 nanometers.

25. The IMOD of claim 21, wherein the means for partially absorbing light comprises:
an absorber layer;
a first high-index layer disposed between the absorber layer and the substrate, the first high-index layer having a relatively higher index of refraction than that of the substrate;
a low-index layer disposed between the absorber layer and the first high-index layer, the low-index layer having a relatively lower index of refraction than that of the first high-index layer; and
a second high-index layer disposed between the absorber layer and the mirror, the second high-index layer having a relatively higher index of refraction than that of the low-index layer.

26. The IMOD of claim 21, wherein the positioning means comprises a plurality of protrusions disposed on the means for partially absorbing light or the mirror, the protrusions being capable of preventing contact between areas of the mirror and areas of the means for partially absorbing light.

27. The IMOD of claim 26, wherein each of the protrusions extends between 5 and 20 nm from the surface on which the protrusion is formed.

28. A method of forming an interferometric modulator (IMOD), the method comprising:
forming an absorber stack on a substantially transparent substrate, the absorber stack including:
an absorber layer;
a first high-index layer disposed between a first side of the absorber layer and the substrate, the first high-index layer having a relatively higher index of refraction than that of the substrate;
a low-index layer disposed between the first side of the absorber layer and the first high-index layer, the low-index layer having a relatively lower index of refraction than that of the first high-index layer; and
a second high-index layer disposed on a second side of the absorber layer, the second high-index layer having a relatively higher index of refraction than that of the low-index layer; and
forming a mirror stack capable of being positioned in a plurality of positions relative to the absorber stack to form a plurality of gap heights between the mirror stack and the absorber stack, each reflective color of a plurality of reflective colors of the IMOD corresponding with a gap height of the plurality of gap heights.

29. The method of claim 28, wherein the second high-index layer includes at least one material selected from the list of materials consisting of SiNₓ and ZrO₂.

30. The method of claim 28, further comprising forming a plurality of protrusions on the absorber stack or the mirror stack, the protrusions being capable of preventing contact between areas of the mirror stack and areas of the absorber stack.
